(19) United States
(12) Patent Application Publication
(10) Pub. No.: US 2007/0051930 A1
(43) Pub. Date: Mar. 8, 2007

(54) Near-infrared-absorbing glass, near-infrared-absorbing element having the same and image-sensing device

(75) Inventor: Yoichi Hachitani, Nishitama-gun (JP)

Correspondence Address: NIXON & VANDERHYE, PC, 901 NORTH GLEBE ROAD, 11TH FLOOR, ARLINGTON, VA, 22203, US

(73) Assignee: HOYA CORPORATION, Tokyo (JP)

(21) Appl. No.: 11/516,047

(22) Filed: Sep. 6, 2006

(30) Foreign Application Priority Data
Sep. 6, 2005 (JP) 2005-258193
Dec. 28, 2005 (JP) 2005-378720

(51) Int. Cl. F21V 9/04; G02B 5/22; G02B 5/00

(52) U.S. Cl. 252/587

(57) ABSTRACT

Provided are a near-infrared-absorbing glass having high transmittance in a visible light region, an excellent near infrared absorption property, excellent climate resistance, etc., and is suitable for use as/in a near-infrared-absorbing element such as a near-infrared-absorbing filter, and a near-infrared-absorbing element to which the above near-infrared-absorbing glass is applied, and the near-infrared-absorbing glass contains, by cationic %, 25 to 45% of P⁵⁺, 1 to 10% of Al³⁺, 15 to 30% of Li⁺, 0.1 to 10% of Mg²⁺, 0.1 to 20% of Ca²⁺, 0.1 to 20% of Sr²⁺, 0.1 to 20 Ba²⁺ and 1 to 8% of Cu²⁺ and contains, as anionic components, 25 to 50 anionic % of F⁻ and O²⁻.

### FIELD OF THE INVENTION

The present invention relates to a near-infrared-absorbing glass, a near-infrared-absorbing element having the same, a process for the production of the element and an image-sensing device. More specifically, the present invention relates to a near-infrared-absorbing glass suitable for a near-infrared-absorbing element such as a near-infrared-absorbing filter for correcting the color sensitivity of an image-sensing device such as CCD or CMOS for use particularly in a digital camera, a VTR camera or the like, a near-infrared-absorbing element as is described above, a process for efficiently producing the element and an image-sensing apparatus having the near-infrared-absorbing element.

### BACKGROUND ART

A solid image-sensing device such as CCD or the like for use in a digital camera or a VTR camera has a spectral sensitivity ranging from a visible light region to about 1,100 nm. A filter that absorbs light in a near infrared region is used to obtain an image close to an image of luminosity factor to human eyes. As a glass for this purpose, there has been used a glass obtained by adding CuO to a phosphate glass. However, the phosphate glass has poor climate resistance, and there is a defect that the phosphate glass causes surface roughening or opacification when exposed to high temperatures and high humidity for a long period of time. There has been hence developed a fluorine-component-containing near-infrared-absorbing filter glass that has the basic composition containing a fluorophosphate glass excellent in climate resistance, and such a glass is commercially available.

As a glass of the above type, for example, there has been disclosed a near-infrared-absorbing filter glass obtained by adding Cu to a fluorophosphate glass (for example, see JP-A-2-204342).

Since, however, a near-infrared-absorbing filter formed from a conventional Cu-containing fluorophosphate glass has no sufficient absorption at a wavelength of 1,000 to 1,200 nm, it is required to form a multi-layered film for infra red absorption by a method of vapor deposition, sputtering or the like. It has been hence difficult to provide near-infrared-absorbing filters at a low cost due to a coating cost.

A near-infrared-absorbing filter glass disclosed in the above JP-A-2-204342 has a large aluminum element content as shown in Examples, and the absorption at a wavelength of 1,000 to 1,200 nm is not necessarily sufficient.

In recent years, further, it is required to decrease an environmental load with regard to glass production, and gas generated during the melting of a glass is brought into question in many cases. In particular, there are legal controls imposed on nitrogen oxide, sulfur oxide and other air contaminants, and it is required to arrange that they are not discharged into atmosphere. Generally, they are rendered harmless in gas treatment facilities of a large scale and then discharged. However, the maintenance and management of such facilities require a very large cost.

In a near-infrared-absorbing filter formed of a conventional Cu-containing fluorophosphate glass, a carbonate compound, a nitrate compound, a hydroxide, etc., are used as raw materials to make it easier to dissolve and refine the glass, and Cu is rendered divalent with a gas generated by decomposition of the raw materials in order to realize a high transmittance. When raw materials for the glass are dissolved, however, the carbonate compound, nitrate compound, hydroxide, etc., are decomposed to generate a gas. Further, the volatilization of fluorine is also promoted together with the gas, so that it is said that the dissolving of a glass of the above type involves a large environmental load. Further, it is difficult to control the volatilization of fluorine since the volume of the discharge gas is large, and it has been hence difficult to produce a glass having a large fluorine content.

### DISCLOSURE OF THE INVENTION

Problems to be Solved by the Invention

Under the circumstances, it is an object of the present invention to provide a near-infrared-absorbing glass that has excellent transmittance in a visible light region, excellent absorption in a near infrared region and excellent climate resistance and that is suitable for a near-infrared-absorbing element such as a near-infrared-absorbing filter, a near-infrared-absorbing element as is described above, a process for efficiently producing the element and an image-sensing device having the above near-infrared-absorbing element.

Means to Solve the Problems

For achieving the above object, the present inventor has made diligent studies, and as a result, it has been found that a glass having specific contents of specific cationic and anionic components is suitable as a near-infrared-absorbing glass for the above object.

Further, it has been found that a near-infrared-absorbing element can be efficiently obtained by heating and precision press-molding a preform formed of the above near-infrared-absorbing glass.

The present invention has been accordingly completed on the basis of the above finding.

That is, the present invention provides

(1) a near-infrared-absorbing glass comprising, by cationic %, 25 to 45% of P⁵⁺, 1 to 10% of Al³⁺, 15 to 30% of Li⁺, 0.1 to 10% of Mg²⁺, 0.1 to 20% of Ca²⁺, 0.1 to 20% of Sr²⁺, 0.1 to 20 Ba²⁺ and 1 to 8% of Cu²⁺ and comprising, as anionic components, 25 to 50 anionic % of F⁻ and O²⁻,

(2) a near-infrared-absorbing glass as recited in the above (1), wherein the ratio of the content of Al³⁺ to the content of p⁵⁺ by cationic ratio, Al³⁺/P⁵⁺, is from 0.05 to 0.30,

(3) a near-infrared-absorbing glass as recited in the above (1) or (2), wherein the ratio of the total content of Mg²⁺ and Ca²⁺ to the total content of Mg²⁺, Ca²⁺, Sr²⁺ and Ba²⁺ by cationic ratio, (Mg²⁺+Ca²⁺)/(Mg²⁺+Ca²⁺+Sr²⁺+Ba²⁺), is from 0.5 to less than 1.0,

(4) a near-infrared-absorbing glass as recited in any one of the above (1) to (3), wherein the ratio of the content of Li⁺ to the total content of Li⁺, Na⁺ and K⁺ by cationic ratio, Li⁺/(Li⁺+Na⁺+K⁺), is from 0.8 to 1.0,

(5) a near-infrared-absorbing glass as recited in any one of the above (1) to (4), which has a transmittance property represented by a transmittance of less than 15% at a wavelength of 1,200 nm when it is thickness-adjusted such that it exhibits a transmittance of 50% at a wavelength of 615 nm in a spectral transmittance at a wavelength of 500 to 700 nm,

(6) a near-infrared-absorbing glass as recited in the above (5), which further has the transmittance property represented by

a transmittance of 83% or more at a wavelength of 400 nm,

a transmittance of 88% or more at a wavelength of 500 nm,

a transmittance of 55% or more at a wavelength of 600 nm,

a transmittance of less than 8% at a wavelength of 700 nm,

a transmittance of less than 1% at a wavelength of 800 nm,

a transmittance of less than 1% at a wavelength of 900 nm,

a transmittance of less than 3% at a wavelength of 1,000 nm, and

a transmittance of less than 7% at a wavelength of 1,100 nm,

(7) a process for the production of the near-infrared-absorbing glass recited in any one of the above (1) to (6), which comprises providing only solid oxides and fluorides as raw materials, heating and melting said raw materials and forming the glass,

(8) A near-infrared-absorbing element having the near-infrared-absorbing glass recited in any one of the above (1) to (6) or the near-infrared-absorbing glass produced by the process recited in the above (7),

(9) a near-infrared-absorbing element as recited in the above (8), which is a near-infrared-absorbing filter having a glass plate formed of a near-infrared-absorbing glass,

(10) a near-infrared-absorbing element as recited in the above (8) or (9), which is an optical low-pass filter,

(11) a near-infrared-absorbing element as recited in the above (8) or (10), which is a lens,

(12) a process for the production of a near-infrared-absorbing element, which comprises heating and precision press-molding a preform formed of the near-infrared-absorbing glass recited in any one of the above (1) to (6) or a near-infrared-absorbing glass produced by the process recited in the above (7),

(13) an image-sensing apparatus comprising the near-infrared-absorbing element recited in the above (8) and a semiconductor image-sensing device for receiving light to be transmitted through it, and

(14) an image-sensing apparatus comprising the near-infrared-absorbing element produced by the process recited in the above (12) and a semiconductor image-sensing device for receiving light to be transmitted through it.

Effect of the Invention

According to the present invention, there can be provided a near-infrared-absorbing glass that has excellently high transmittance in a visible light region, an excellent near-infrared-absorbing property and excellent climate resistance and that is suitable for a near-infrared-absorbing element such as a near-infrared-absorbing filter, a near-infrared-absorbing element as is described above, a process for efficiently producing the element and an image-sensing apparatus having the above near-infrared-absorbing element.

### BRIEF DESCRIPTION OF DRAWINGS

FIG. 1 is a chart showing spectral transmittances of near-infrared-absorbing glasses obtained in Example 1 and Comparative Example 1.

### PREFERRED EMBODIMENTS OF THE INVENTION

First, the near-infrared-absorbing glass of the present invention will be explained with regard to its transmittance property.

In a preferred embodiment of the near-infrared-absorbing glass of the present invention, when the near-infrared-absorbing glass has such a thickness that it exhibits a transmittance of 50% at a wavelength of 615 nm in a spectral transmittance at a wavelength of 500 to 700 nm, the transmittance thereof at a wavelength of 1,200 nm is less than 15%, preferably 13% or less. In a more preferred embodiment, not only the near-infrared-absorbing glass exhibits the above property, but also it exhibits the property represented by

a transmittance of 83% or more, preferably 85% ore more, more preferably 87% or more, at a wavelength of 400 nm,

a transmittance of 88% or more, preferably 89% or more, more preferably 90% or more, at a wavelength of 500 nm,

a transmittance of 55% or more at a wavelength of 600 nm,

a transmittance of less than 8% at a wavelength of 700 nm,

a transmittance of less than 1% at a wavelength of 800 nm,

a transmittance of less than 1% at a wavelength of 900 nm,

a transmittance of less than 3%, preferably 2% or less, at a wavelength of 1,000 nm, and

a transmittance of less than 7%, preferably 5% or less, at a wavelength of 1,100 nm.

That is, the absorption of near infra red at a wavelength of 700 to 1,200 nm is large, and the absorption of visible light at a wavelength of 400 to 600 nm is small. The transmittance as used herein refers to a value obtained by providing a glass sample having two optically polished flat surfaces that are in parallel with each other, causing light to enter the glass sample through one of the flat surfaces at right angles with the flat surface and dividing the intensity of light that comes out through the other of the above two flat surfaces with the intensity that the light has before caused to enter the sample. This transmittance is also called “external transmittance”.

Owing to the above transmittance property, the color sensitivity of a semiconductor image-sensing device such as CCD, CMOS or the like for use in a digital camera or a VTR camera can be corrected. In particular, the absorption of near-infrared light at a wavelength of 700 to 1,200 nm is increased, so that the color sensitivity of a semiconductor image-sensing device can be excellently corrected without providing a near-infrared-blocking multi-layered film and that excellent color reproduction can be hence realized as an image sensing apparatus.

In the process for the production of a near-infrared-absorbing glass, provided by the present invention, only solid oxide and fluoride are used as raw materials, and the above raw materials are heated, melted and shaped (molded) to obtain a near-infrared-absorbing glass.

Specifically, the raw materials are limited to only solid oxide raw materials including a phosphate raw material and a solid fluoride raw material, and the process uses none of a carbonate, a nitrate, a sulfate, a hydroxide, a hydrate, an aqueous solution and the like. In this manner, discharge gas emitted during melting can be controlled so that the amount thereof is small and the environmental load is decreased. At the same time the volatilization of fluorine is suppressed and a glass having a large content of fluorine can be melted. Further, the contamination and damage of a furnace or an ambient atmosphere by the volatilization of fluorine can be suppressed, so that the glass can be efficiently produced.

The composition of the near-infrared-absorbing glass of the present invention will be explained below. A percentage for a content of a cationic component or a total content of cationic components hereinafter represents cationic %, and a percentage for a content of an anionic component hereinafter represents anionic % unless otherwise specified. Further, a content ratio of cationic components (including a ratio to a total content) is based cationic %.

The near-infrared-absorbing glass of the present invention comprises, by cationic %, 25 to 45% of P⁵⁺, 1 to 10% of Al³⁺, 15 to 30% of Li⁺, 0.1 to 10% of Mg²⁺, 0.1 to 20% of Ca²⁺, 0.1 to 20% of Sr²⁺, 0.1 to 20 Ba²⁺ and 1 to 8% of Cu²⁺ and comprises, as anionic components, 25 to 50 anionic % of F⁻ and O²⁻.

P⁵⁺ is a basic component of the fluorophosphate glass and is an essential component that brings the absorption by Cu²⁺ in an infra red region. When the content of P⁵⁺ is less than 25%, a color transmitted through the glass is deteriorated and is greenish. When it exceeds 45%, the glass is degraded in climate resistance and devitrification resistance. The content of P⁵⁺ is therefore limited to 25 to 45%, and it is preferably 30 to 40%.

Al³⁺ is an essential component that improves the fluorophosphate glass in devitrification resistance, heat resistance, thermal impact resistance, mechanical strength and chemical durability. When the content of Al³⁺ is less than 1%, none of these effects is produced, and when it exceeds 10%, the property of absorbing near infrared is degraded. The content of Al³⁺ is therefore limited to 1 to 10%. It is preferably 2 to 8%, more preferably 2 to 7%.

In addition, the ratio of content of Al³⁺ to the content of P⁵⁺, Al³⁺/P⁵⁺, is an important factor for satisfying both absorption in a near infrared region and transmission in a visible light region. When the above ratio is less than 0.05, the durability tends to be poor. When it exceeds 0.30, the absorption in the near infrared region is small, and the transmission of visible light tends to decrease. The above ratio (Al³⁺/P⁵⁺) is therefore preferably adjusted in the range of 0.05 to 0.30, more preferably in the range of 0.05 to 0.25, still more preferably in the range of 0.05 to 0.20.

Li⁺ is an essential component for improving the glass in meltability, devitrification resistance and transmittance in a visible light region. When the content of Li⁺ is less than 15%, such effects are not produced. When it exceeds 30%, the glass is degraded in durability and processability. The content of Li⁺ is therefore limited to 15 to 30%. It is preferably 17 to 30%, more preferably 20 to 30%.

Mg2+ is an essential component that improves the glass in devitrification resistance, durability and processability. When the content of Mg²⁺ is less than 0.1%, such effects are not produced. When it exceeds 10%, the devitrification resistance is degraded. The content of Mg²⁺ is therefore limited to 0.1 to 10%, and it is preferably 1 to 9%, more preferably 1 to 8%.

Ca²⁺ is a useful component that improves the glass in devitrification resistance, durability and processability. When the content of Ca²⁺ is less than 0.1%, such effects are not produced. When it exceeds 20%, the devitrification resistance is degraded. The content of Ca²⁺ is therefore limited to 0.1 to 20%, and it is preferably 5 to 15%.

Sr²⁺ is a useful component that improves the glass in devitrification resistance and meltability. When the content of Sr²⁺ is less than 0.1%, no such effects are produced. When it exceeds 20%, the devitrification resistance is degraded. The content of Sr²⁺ is therefore limited to 0.1 to 20%, and it is preferably 1 to 10%.

Ba²⁺ is a useful component that improves the glass in devitrification resistance and meltability. When the content of Ba²⁺ is less than 0.1%, no such effects are produced. When it exceeds 20%, the devitrification resistance is degraded. The content of Ba²⁺ is therefore limited to 0.1 to 20%, and it is preferably 1 to 10%.

It has a significant influence on the devitrification resistance, durability, processability and specific gravity of the glass how alkaline earth metal ions are selected to incorporate them into the glass. That is, the ratio of the total content of Mg²⁺ and Ca²⁺ to the total content of Mg²⁺, Ca²⁺, Sr²⁺ and Ba²⁺, (Mg²⁺+Ca²⁺)/(Mg²⁺+Ca²⁺+Sr²⁺+Ba²⁺), is less than 0.5, the glass is liable to be poor in devitrification resistance, durability and processability and the specific gravity thereof tends to increase. It is therefore preferred to the above ratio of (Mg²⁺+Ca²⁺)/(Mg²⁺+Ca²⁺+Sr²⁺+Ba²⁺) in the range of 0.5 to less than 1.0.

When the content of Cu²⁺ is less than 1%, the infrared absorption is small, and when it exceeds 8%, the devitrification resistance is degraded. The content of Cu²⁺ is therefore limited to 1 to 8%. It is preferably 2 to 7%.

F⁻ is an essential anionic component that decreases the melting point of the glass and improves the glass in climate resistance. In the glass of the present invention containing F⁻, the melting temperature of the glass is decreased, the reduction of Cu²⁺ is suppressed and predetermined optical properties can be obtained. When the content of F⁻ is less than 25%, the climate resistance is degraded. When it exceeds 50%, the content of O²⁻ is relatively decreased, so that coloring occurs at and around 400 nm due to monovalent Cu⁺. The content of F⁻ is therefore limited to 25 to 50%, and it is preferably 30 to 45%.

O²⁻ is a particularly important anionic component for the near-infrared-absorbing glass of the present invention, and in a preferred embodiment, the entirety of the anionic portion excluding F⁻ in the glass is constituted of an O²⁻ component. When the content of O²⁻ is less than 50%, divalent Cu²⁺ is reduced to monovalent Cu⁺, so that the absorption in a short wavelength region, in particular at and around 400 nm, is large, which leads a color to be greenish. When it exceeds 75%, the glass has a high viscosity and has a high melting temperature, so that the transmittance is liable to be degraded. The content of O²⁻ is preferably 50 to 75%, more preferably 55 to 70%.

The glass of the present invention may contain a small amount of other anionic components such as Cl⁻, Br⁻, I⁻, etc., together with the above F⁻ and O²⁻.

While Na⁺, K⁺ and Zn²⁺ have an effect on improvements of the meltability and devitrification resistance, they impair the near-infrared-absorbing property, so that it is desirable to add none of these.

That is, the ratio of content of Li⁺ of alkali metal ions is to be increased, and it is preferred to adjust the ratio of content of Li⁺ to the total content of Li⁺, Na⁺ and K⁺, Li⁺/(Li⁺+Na⁺+K⁺), to 0.8 to 1.0, and it is more preferred to adjust the above ratio to 0.9 to 1.0.

Pb is very harmful, and it is hence desirable to use no Pb in the present invention.

Further, while As has an effect on improvement of transmittance, it is very harmful, so that it is desirable to use no As in the present invention. Sb also has an effect on improvement of transmittance, but for the same reason, it is preferred to use no Sb.

In the production of the above near-infrared-absorbing glass, raw materials in the form of a solid powder are used as glass raw materials as described above. For example, only oxides including anhydrous phosphate and a fluoride raw material are prepared as required, these raw materials are weighed so as to obtain a desired composition and mixed, and the mixture is then melted in a refractory crucible at approximately 800 to 900° C. In this case, for suppressing the volatilization of a fluorine component, it is desirable to use a refractory cover of platinum or the like. A glass in a molten state is stirred and refined and then the glass is caused to flow out for molding (shaping).

As a method for molding (shaping) the glass, there can be employed a known method such as a casting, pipe-flowing, rolling or pressing method.

The near-infrared-absorbing glass of the present invention is excellent in climate resistance. For use for a long period of time, the glass is required to have excellent climate resistance. When the climate resistance is low, fogging occurs on the glass surface, and the glass is no longer usable in the field of a near-infrared-absorbing element and the like. The climate resistance as used herein is tested by holding an optically polished glass sample under conditions including a temperature of 60° C. and a relative humidity of 80% for 1,000 hours and then visually observing the optically polished surface of the sample for a yellowing state. As a result, when no yellowing state is observed, it can be confirmed that such a glass has climate resistance sufficient for use for a long period of time. With regard to the near-infrared-absorbing glass of the present invention, it has been confirmed that no yellowing state is observed in the test under the above conditions and that the near-infrared-absorbing glass of the present invention hence has excellent climate resistance.

The near-infrared-absorbing element of the present invention has the above near-infrared-absorbing glass or a near-infrared-absorbing glass produced by the above process. The near-infrared-absorbing element of the present invention may be a near-infrared-absorbing element a part of which uses the above near-infrared-absorbing glass, such as an element in which a glass plate formed of the near-infrared-absorbing glass is attached to a quartz plate, or a near-infrared-absorbing element which is entirely formed of the near-infrared-absorbing glass.

For example, the above glass plate formed of the near-infrared-absorbing glass is produced as follows.

First, a refined and homogenized molten glass is cast from a pipe into a casting mold and shaped into a glass block having a large thickness and a large size. For example, there is prepared a casting mold that is constituted of a flat and horizontal bottom surface, a pair of side walls in parallel with each other across the bottom surface and a blocking plate positioned from one side wall to the other side wall to close one opening, and a homogenized molten glass is cast into the above mold from a pipe made of a platinum alloy at a constant flow rate. A cast molten glass spreads in the mold to be shaped into a plate-shaped glass, which is defined by the pair of side walls to have a constant width. The thus-shaped plate-shaped glass is continuously withdrawn from the opening portion of the mold. In this case, molding (shaping) conditions such as the form and dimensions of the mold, the flow rate of the molten glass, etc., are determined as required, whereby there can be formed a glass block having a large size and a large thickness.

The thus-shaped glass block is transferred into an annealing furnace, which is pre-heated to a temperature around the transition temperature of the glass, and gradually cooled to room temperature. The glass block that has been gradually cooled to remove a strain is subjected to accurate slicing, grinding and polishing, whereby glass plate(s) having both surfaces optically polished can be obtained.

When a near-infrared-absorbing filter is produced (by using the above glass plate), a near-infrared-absorbing glass (that is the above glass plate) is attached to one surface of a quartz plate having both surfaces optically polished, and a plate-shaped optical glass that transmits visible light and that has both surfaces optically polished, such as BK-7 (borosilicate optical glass) is attached to the other surface of the quartz plate. While the near-infrared-absorbing filter is constituted to have the above structure, one more plate-shaped optical glass that transmits visible light and that has both surfaces optically polished (e.g., BK-7) may be attached to the other surface of the above plate-shaped optical glass. An optical multi-layered film may be formed on the filter surface as required.

While a case where the glass block is processed to form a glass plate is explained above, the glass block may be ground and polished to produce a lens or may be processed to produce a product having other form.

Since the near-infrared-absorbing glass of the present invention has a low glass transition temperature, optical elements such as a lens, a diffraction grating, etc. can be produced therefrom by precision press-molding (mold-shaping) without using any machine-applied processing such as grinding and polishing of their optical-function surfaces. For example, molding surfaces of a known press mold material such as SiC, a carbide material or the like are highly accurately processed so that they have reverse forms of lens surfaces of an aspherical lens, whereby upper and lower mold members are prepared, and a glass preform formed of the near-infrared-absorbing glass of the present invention is heated and precision press-molded with these upper and lower mold members and optionally with a known sleeve or upper and lower mold guide member(s). The forms of the molding surfaces are accurately transferred to the glass in the above manner, whereby an aspherical lens formed of the near-infrared-absorbing glass of the present invention can be produced.

The thus-obtained aspherical lens is a near-infrared-absorbing element having the function of near infrared absorption and can constitute part or the whole of an optical system for forming an image of an object on a semiconductor image-sensing device, so that the number of optical parts in an image-sensing apparatus can be decreased and that space saving and cost reduction can be realized at the same time.

Molding surfaces of a press mold material are highly accurately processed so that they have reverse forms of a diffraction grating to prepare upper and lower mold members, and a glass preform is precision press-molded with the above mold in the same manner as in the above-described method, whereby a diffraction grating formed of the near-infrared-absorbing glass of the present invention can be also produced.

The thus-obtained near-infrared-absorbing element with a diffraction grating works as an optical low-pass filter for light that enters a semiconductor image-sensing device. Since a near-infrared-absorbing filter and an optical low-pass filter can be therefore constituted of one element, the number of optical parts in an image-sensing apparatus can be decreased, and space saving and cost reduction can be realized at the same time.

In addition, molding surfaces of a press mold material are formed in a reverse form of lens surfaces (e.g., lens surfaces of an aspherical lens) and at the same time processed in a reverse form of grooves of a diffraction grating, and precision press-molding is carried out in the same manner as in the above method, whereby there can be produced a near-infrared-absorbing element that has the function of near infrared absorption, the function of an optical low-pass filter and the function of a lens together.

A known mold release film may be formed on the molding surface(s) of a press mold as required. Various conditions of the precision press-molding can be determined as required depending upon specifications of an intended near-infrared-absorbing element while applying known conditions.

By producing near-infrared-absorbing elements according to the above precision press-molding, there can be highly productively produced elements for which mass-production by grinding and polishing is not suitable, such as an aspherical lens, an optical low-pass filter with a diffraction grating, an aspherical lens that functions as an optical low-pass filter and has a diffraction grating, and the like.

An optical multi-layered film such as an anti-reflection film may be formed on the surface of a near-infrared-absorbing element as required.

According to the near-infrared-absorbing element of the present invention, the transmittance of visible light is high, and the absorption of near infrared light is large, so that the color sensitivity of a semiconductor image-sensing device can be excellently corrected.

The present invention also provides an image-sensing apparatus having the above near-infrared-absorbing element and a semiconductor image-sensing device for receiving light that passes through the element and an image-sensing apparatus having a near-infrared-absorbing element produced by the above production process and a semiconductor image-sensing device for receiving light that passes through the element.

### EXAMPLES

The present invention will be explained more in detail with reference to Examples hereinafter, while the present invention shall not be limited by these Examples.

### Examples 1-6

Oxide materials including phosphates and fluoride materials were weighed so as to obtain a composition shown in Table 1, and they were mixed and melted in a crucible made of platinum. Glasses in Examples 1 to 6 were melted at 800 to 900° C., and a glass in Comparative Example 1 was melted at 1,300° C.

Each glass was stirred and refined, and then it was cast on an iron plate to form a block. The glass block was transferred into a furnace, which was pre-heated to a temperature around a glass transition temperature, and annealed to room temperature to give near-infrared-absorbing glasses.

Samples for measurements were taken from the above-obtained blocks by cutting and measured for various properties as follows. Table 1 shows the results.

(1) Transmittance Property

A glass that was polished and had a thickness shown in Table 1 was measured for spectral transmittances at a wavelength of 200 to 1,200 with a spectrophotometer. Table 1 shows a transmittance at each wavelength.

(2) Thermal Expansion Coefficient

Measured according to Japan Optical Glass Industry Society Standard JOGIS-08.

(3) Climate Resistance

A polished sample was held under conditions including a temperature of 60° C. and a relative humidity of 80% for 1,000 hours and then the surface was observed for an opacification or fogging.

(4) Transition Temperature (Tg) and sag Temperature (Ts)

Measured with an apparatus for thermomechanical analysis, supplied by Rigaku Corporation, at a temperature elevation rate of 4° C./minute.

TABLE 1

| | | | | | | |
|---|---|---|---|---|---|---|
| Ex. 1 | Ex. 2 | Ex. 3 | Ex. 4 | Ex. 5 | Ex. 6 | CEx. 1 |

| | | | | | | | | | |
|---|---|---|---|---|---|---|---|---|---|
| Glass | P | cat % | 37.0 | 33.3 | 42.3 | 39.5 | 37.3 | 35.0 | 29.0 |
| Composition | Al | cat % | 4.5 | 2.8 | 6.9 | 4.8 | 4.5 | 6.5 | 14.0 |
| | Li | cat % | 23.6 | 24.8 | 21.7 | 18.9 | 23.8 | 21.4 | 24.0 |
| | Na | cat % | 0.0 | 0.0 | 0.0 | 0.0 | 0.0 | 0.0 | 7.0 |
| | Mg | cat % | 7.7 | 9.8 | 7.0 | 8.2 | 4.7 | 8.1 | 3.0 |
| | Ca | cat % | 12.9 | 10.5 | 9.2 | 10.7 | 13.0 | 13.0 | 7.0 |
| | Sr | cat % | 4.1 | 7.4 | 6.4 | 7.5 | 4.1 | 4.1 | 5.0 |
| | Ba | cat % | 6.2 | 6.6 | 3.0 | 6.7 | 9.2 | 6.3 | 4.0 |
| | Zn | cat % | 0.0 | 0.0 | 0.0 | 0.0 | 0.0 | 0.0 | 4.0 |
| | Cu | cat % | 4.0 | 4.8 | 3.5 | 3.8 | 3.3 | 5.6 | 3.0 |
| | Total | cat % | 100.0 | 100.0 | 100.0 | 100.1 | 99.9 | 100.0 | 100.0 |
| | Li/R | | 1.00 | 1.00 | 1.00 | 1.00 | 1.00 | 1.00 | 0.77 |
| | Al/P | | 0.12 | 0.08 | 0.16 | 0.12 | 0.12 | 0.19 | 0.48 |
| | (Mg + Ca) | | 0.67 | 0.59 | 0.63 | 0.57 | 0.57 | 0.67 | 0.43 |
| | R′ | | | | | | | | |
| | O | an % | 65.0 | 60.0 | 72.0 | 67.0 | 65.0 | 61.5 | 60.0 |
| | F | an % | 35.0 | 40.0 | 28.0 | 33.0 | 35.0 | 38.5 | 40.0 |
| | Total | an % | 100.0 | 100.0 | 100.0 | 100.0 | 100.0 | 100.0 | 100.0 |
| Transmittance | Measurement | mm | 0.45 | 0.30 | 0.36 | 0.35 | 0.40 | 0.30 | 0.45 |
| property | thickness | | | | | | | | |
| | T400 | % | 84.5 | 85.8 | 85.8 | 84.0 | 86.0 | 84.5 | 90.0 |
| | T500 | % | 89.0 | 89.8 | 89.5 | 88.8 | 89.8 | 89.0 | 91.0 |
| | T600 | % | 60.0 | 60.7 | 60 | 60 | 60.2 | 62.0 | 60.0 |
| | T700 | % | 7.0 | 5.0 | 6.5 | 6.2 | 5.2 | 6.7 | 8.7 |
| | T800 | % | <1 | <1 | <1 | <1 | <1 | <1 | 1.4 |
| | T900 | % | <1 | <1 | <1 | <1 | <1 | <1 | 1.4 |
| | T1000 | % | 1.5 | 1.1 | 2.0 | 1.7 | 1.2 | 1.9 | 4.0 |
| | T1100 | % | 5.0 | 4.5 | 5.5 | 5.0 | 4.0 | 5.2 | 10.0 |
| | T1200 | % | 11.5 | 9.2 | 12.8 | 12.0 | 10.1 | 12.2 | 20.5 |

| | | | | | | | | |
|---|---|---|---|---|---|---|---|---|
| Glass | ° C. | 350 | 325 | 387 | 380 | 340 | 335 | 335 |
| transition | | | | | | | | |
| temperature | | | | | | | | |
| [Tg] | | | | | | | | |
| Sag | ° C. | 390 | 365 | 427 | 420 | 380 | 380 | 380 |
| temperature | | | | | | | | |
| [Ts] | | | | | | | | |

| | | | | | | | |
|---|---|---|---|---|---|---|---|
| Average linear | 160 | 170 | 140 | 150 | 165 | 155 | 170 |
| expansion coefficient | | | | | | | |
| at 100-300° C. | | | | | | | |
| (×10⁻⁷/° C.) | | | | | | | |
| Climate resistance | NC | NC | NC | NC | NC | NC | NC |

Notes:
Ex. = Example,
CEx. = Comparative Example
R = Li + Na + K,
R′ = Mg + Ca + Sr + Ba
NC = No change
Additional notes to Table 1:
1) T400, T500, T600, T700, T800, T1000, T1100 and T1200 stand for transmittances at wavelengths of 400 nm, 500 nm, 600 nm, 700 ma, 800 nm, 1,000 nm, 1,100 nm and 1,200 nm, respectively.
2) Li/R: Li⁺/(Lii⁺ + Na⁺ + K⁺)
3) Al/P: Al³⁺/P⁵⁺
4) (Mg + Ca)/R′: (Mg²⁺ + Ca²⁺)/(Mg²⁺ + Ca²⁺ + Sr²⁺ + Ba²⁺)

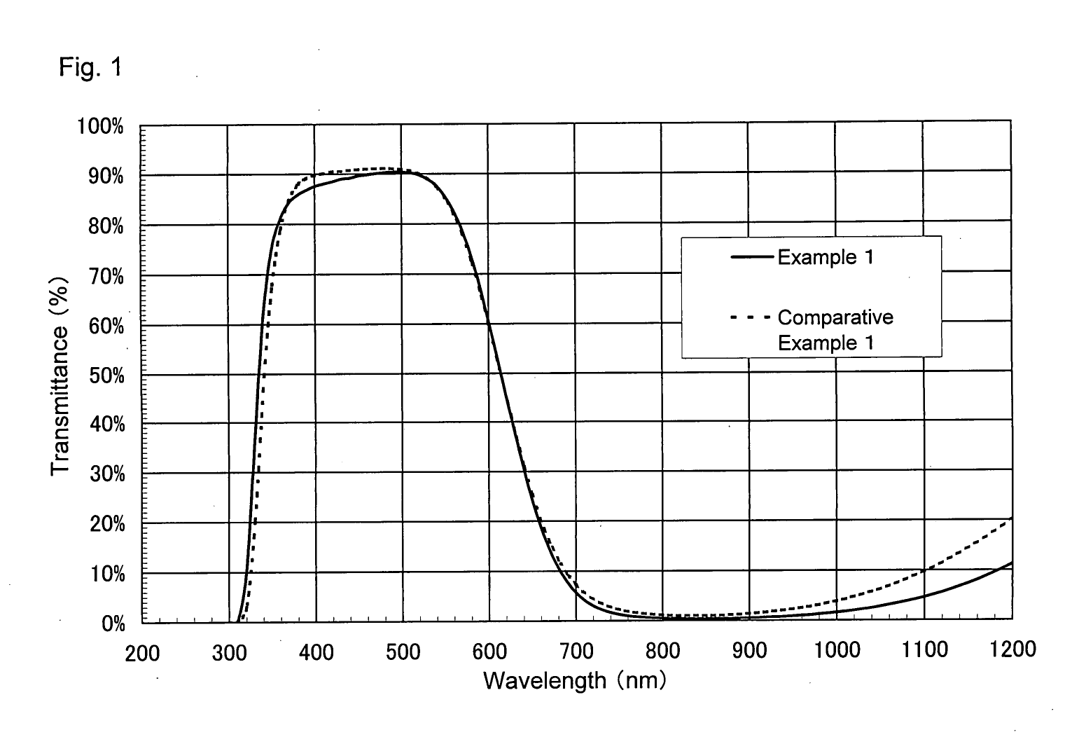

FIG. 1 shows spectral transmittances of glasses of Example 1 and Comparative Example 1. Spectral transmittances were obtained when the thickness of each of the glass of Example 1 and the glass of Comparative Example 1 was adjusted such the transmittance at a wavelength of 615 nm was 50%, that is, the glasses of Example 1 and Comparative Example 1 had thicknesses as shown in Table 1. The glass of Example 1 has sufficient transmittance to visible light and sufficient absorption of near infrared light and has a transmittance property that the color sensitivity of a semiconductor image-sensing device can be excellently corrected without forming a near infrared blocking coating. On the other hand, the glass of Comparative Example 1 has low near infrared absorption function, so that its property is that it is desirable to form a near infrared blocking coating for completing the color correction function of a semiconductor image-sensing device.

In the above manner, there were obtained near-infrared-absorbing glasses having a glass transition temperature of less than 400° C., a sag temperature of less than 450° C. and an average linear expansion coefficient, measured at 100 to 300° C., of greater than 130×10⁻⁷/° C. but smaller than 180×10⁻⁷/° C.

### Example 7

Plate-shaped glasses formed of glasses having the same compositions as those in Examples 1 to 6 were obtained (molded) by carrying out glass dissolving, refining, homogenizing and mold-casting in the same manner as in Examples 1 to 6. Each plate-shaped glass was sliced and both surfaces of each of the sliced glasses were optically polished to obtain glass plates having predetermined thicknesses. These glass plates were dice-processed to give near-infrared-absorbing glass plates having predetermined thicknesses and sizes. The thickness of each of the glass plates was adjusted such that the transmittance at a wavelength of 615±10 nm was 50% (thicknesses corresponding to measurement thicknesses in Table 1), and each glass plate had a size of 10 mm×10 mm to 30 mm×30 mm. Then, a quartz processed in the form of a plate and two thin-plate glasses formed of an optical glasses (BK-7) each were prepared, and both surfaces of each plate were optically polished. A glass plate formed of a near-infrared-absorbing glass, the quartz plate and two BK-7 thin-plate glasses were stacked in this order while optically polished surfaces thereof were in contact with each other, and an anti-reflection film was provided on each of the outermost surfaces, to produce a near-infrared-absorbing element having the function of a near-infrared-absorbing filter. Images were taken by arranging the above element in front of the light receiving surface of a semiconductor image-sensing device such as CCD, CMOS or the like. Images taken by the above arrangement using the elements of this Example were observed to show that excellent color correction was attained.

### Example 8

A glass melt was prepared by melting, refining and homogenizing a glass in the same manner as in Examples 1 to 6, and the glass melt was caused to flow down from a nozzle made of platinum. A proper amount of the glass melt was received with a receiving mold and shaped into a spherical glass preform. The thus-shaped preform was once cooled to room temperature and in a non-oxidizing atmosphere containing nitrogen gas or a mixture of nitrogen with hydrogen, the preform was again softened by re-heating and pressed with a press mold. The molding surfaces of the press mold were accurately processed in advance in a reverse form of an intended optical element, and the forms of these molding surfaces were accurately transferred to the glass in the above pressing step. The press-molded product was cooled in the press mold to a temperature at which the glass was not deformed, and then it was taken out from the press mold and annealed. In the above manner, optical elements formed of the glasses of Examples 1 to 6, such as spherical lenses and diffraction gratings, were obtained. Further, an element having a diffraction grating on a lens surface can be also produced by precision press-molding.

In addition, a spherical glass preform may be produced by preparing a glass block formed of the glass of any one of Example 1 to 6 in the same manner as in Example 7. And, an optical element such as an aspherical lens or a diffraction grating or a near-infrared-absorbing element having a diffraction grating on a surface may be produced by precision press-molding in the same manner as in the above.

With regard to the form of a lens, there can be produced lenses with various forms such as a convex meniscus form, a concave meniscus form, a biconvex form, a biconcave form, a plano-convex form, a plano-concave form and the like. Preferably, it is arranged that constant near-infrared-absorption can be obtained by equalizing distances of paths of a lens through which light beams going inside a lens pass regardless of distances from the optical axis of the lens. For this purpose, the lens form is preferably a convex meniscus form or a concave meniscus form.

### INDUSTRIAL UTILITY

The near-infrared-absorbing glass of the present invention has excellently high transmittance in a visible light region, an excellent near infrared absorption property, excellent climate resistance, etc., and is suitable for use as/in a near-infrared-absorbing element such as a near-infrared-absorbing filter. Further, the above near-infrared-absorbing filter is particularly suitably used for correcting the color sensitivity of an image-sensing device of CCD, CMOS or the like used in a digital camera or VTR camera.

1. A near-infrared-absorbing glass comprising, by cationic %, 25 to 45% of P⁵⁺, 1 to 10% of Al³⁺, 15 to 30% of Li⁺, 0.1 to 10% of Mg²⁺, 0.1 to 20% of Ca²⁺, 0.1 to 20% of Sr²⁺, 0.1 to 20 Ba²⁺ and 1 to 8% of Cu²⁺ and comprising, as anionic components, 25 to 50 anionic % of F⁻ and O²⁻.

2. The near-infrared-absorbing glass of claim 1, wherein the ratio of the content of Al³⁺ to the content of P⁵⁺ by cationic ratio, Al³⁺/P⁵⁺, is from 0.05 to 0.30.

3. The near-infrared-absorbing glass of claim 1, wherein the ratio of the total content of Mg²⁺ and Ca²⁺ to the total content of Mg²⁺, Ca²⁺, Sr2+ and Ba²⁺ by cationic ratio, (Mg²⁺+Ca²⁺)/(Mg²⁺+Ca²⁺+Sr²⁺+Ba²⁺), is from 0.5 to less than 1.0.

4. The near-infrared-absorbing glass of claim 1, wherein the ratio of the content of Li⁺ to the total content of Li⁺, Na⁺ and K⁺ by cationic ratio, Li⁺/(Li⁺+Na+⁺+K⁺), is from 0.8 to 1.0.

5. The near-infrared-absorbing glass of claim 1, which has a transmittance property represented by a transmittance of less than 15% at a wavelength of 1,200 nm when it is thickness-adjusted such that it exhibits a transmittance of 50% at a wavelength of 615 nm in a spectral transmittance at a wavelength of 500 to 700 nm.

6. Near-infrared-absorbing glass of claim 5, which further has the transmittance property represented by
a transmittance of 83% or more at a wavelength of 400 nm,
a transmittance of 88% or more at a wavelength of 500 nm,
a transmittance of 55% or more at a wavelength of 600 nm,
a transmittance of less than 8% at a wavelength of 700 nm,
a transmittance of less than 1% at a wavelength of 800 nm,
a transmittance of less than 1% at a wavelength of 900 nm,
a transmittance of less than 3% at a wavelength of 1,000 nm, and
a transmittance of less than 7% at a wavelength of 1 ,100 nm.

7. A process for the production of the near-infrared-absorbing glass recited in claim 1, which comprises providing only solid oxides and fluorides as raw materials, heating and melting said raw materials and forming the glass.

8. A near-infrared-absorbing element having the near-infrared-absorbing glass of claim 1 or the near-infrared-absorbing glass produced by the process as described above.

9. The near-infrared-absorbing element of claim 8, which is a near-infrared-absorbing filter having a glass plate formed of a near-infrared-absorbing glass.

10. The near-infrared-absorbing element of claim 8, which is an optical low-pass filter.

11. The near-infrared-absorbing element of claim 8, which is a lens.

12. A process for the production of a near-infrared-absorbing element, which comprises heating and precision press-molding a preform formed of the near-infrared-absorbing glass recited in claim 1 or a near-infrared-absorbing glass produced by the process as described above.

13. An image-sensing apparatus comprising the near-infrared-absorbing element of claim 8 and a semiconductor image-sensing device for receiving light to be transmitted through it.

14. An image-sensing apparatus comprising the near-infrared-absorbing element produced by the process recited in claim 12 and a semiconductor image-sensing device for receiving light to be transmitted through it.
